(19) United States
(12) Patent Application Publication
(10) Pub. No.: US 2016/0078536 A1
(43) Pub. Date: Mar. 17, 2016

(54) Systems and Methods for Managing Retry Orders

(71) Applicant: TRADING TECHNOLOGIES INTERNATIONAL INC., CHICAGO, IL (US)

(72) Inventors: Patrick Joseph Rooney, St. Charles, IL (US); William Tigard Baker, Hoffman Estates, IL (US); Thomas Jeffrey Weiss, Skokie, IL (US)

(21) Appl. No.: 14/486,721

(22) Filed: Sep. 15, 2014

(51) Int. Cl. G06Q 40/04; H04L 29/08

(52) U.S. Cl. CPC G06Q 40/04; H04L 67/10

(57) ABSTRACT

Systems and methods to prevent one or more retry orders from exceeding a bandwidth limitation are disclosed. An example method includes receiving a first retry order and a second retry order, selecting one of the first retry order or the second retry order to communicate to an exchange, communicating the selected one of the first retry order or the second retry order to the exchange, receiving an acknowledgment from the exchange in response to the selected one of the first retry order or the second retry order communicated to the exchange and communicating the other of the selected one of the first retry order or the second retry order to the exchange after receiving the acknowledgment.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

An exchange is typically open during a certain period of time in which trading can occur. In some instances, it is beneficial or favorable to place an order (e.g., to buy or sell) for a tradeable object with the exchange as soon as the exchange opens for trading. A retry order is a type of order for a tradeable object that includes one or more associated parameters, including a retry interval that defines an interval of time between which repeated orders are to be communicated to the exchange. A retry order is typically entered or placed just prior to the opening of the exchange in attempts to gain a favorable position in the exchange by executing the order as soon as the exchange opens. The parameters of the retry order enable the retry order be repeatedly communicated to the exchange at a relatively fast rate until the exchange opens and the order is acknowledged by the exchange.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of an example electronic trading system adapted to communicate one or more example retry orders to an exchange and used to implement the disclosed embodiments.

FIG. 5 illustrates an example window for a graphical user interface for modifying one or more parameters of an example retry order.

FIG. 6 illustrates the example electronic trading system of FIG. 4 having an example retry order control module used to implement the disclosed embodiments.

FIG. 7 illustrates an example sequential order generated by the example control module of FIG. 4 to communicate the one or more example retry orders.

FIG. 8 illustrates an example timing diagram during which the example electronic trading system of FIG. 6 communicates the one or more example retry orders.

FIG. 9 illustrates another example timing diagram during which the example electronic trading system of FIG. 6 communicates the one or more example retry orders.

FIG. 10 illustrates a flow diagram for an example method or process to manage and/or communicate one or more retry orders during a trading session.

FIG. 11 illustrates a flow diagram for another example method or process to manage and/or communicate one or more retry orders during a trading session.

FIGS. 12A and 12B illustrates a flow diagram for another example method or process to manage and/or communicate one or more retry orders during a trading session.

FIG. 13 illustrates a block diagram of the example retry order control module of FIG. 6 that may be used to implement and/or execute the example methods of FIGS. 10, 11, 12A and/or 12B.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to retry orders and, more specifically, to systems and method to manage the submission of one or more retry orders to an electronic exchange.

As used herein, a “retry order” is an order type for a tradeable object that has one or more associated parameters, including at least one parameter that defines or specifies a rate at which the retry order is to be communicated to an exchange or an interval of time between repeated orders. As used herein, a “retry rate” is a measure of an amount of orders to be communicated over a period of time (e.g., 1 second (s)). As used herein, a “retry interval” is a measure of time that is to occur between repeated orders. For example, a retry order may include a price for a tradeable object, a quantity of the tradeable object and a retry interval of 100 milliseconds (ms) or a retry rate of 10 orders per second (orders/s). Therefore, the retry order is repeatedly communicated (e.g., sent, transmitted, submitted, etc.) to an exchange every 100 ms, which results in the retry rate of 10 orders/s.

In general, an exchange is open only for a certain period of time during the day in which trading can occur (e.g., a trading session, an open market, etc.). In some instances, it is beneficial to place an order with as soon as the exchange opens. For example, during the off or closed hours, news or other important information may be released that could affect the value of a certain tradeable object. When the exchange opens for trading, there may be a rush to place orders for that tradeable object. As a result, it is beneficial to place an order with the exchange at the earliest time the exchange is open in an attempt to have the order either filled or placed in a matching queue in an attempt to secure a fill at a desirable value level. Therefore, it is advantageous to be able to communicate an order to an exchange at the very beginning of the trading session to gain a more favorable position relative to orders that are communicated to the exchange at a later time.

A retry order is a type of order for a tradeable object that also includes one or more associated parameters that enable the order to be repeatedly communicated to an exchange until the exchange acknowledges the order. Retry orders are typically placed just prior (e.g., a few seconds, a minute, etc.) to the opening of the exchange. If an order is communicated to the exchange while the exchange is closed, the order is not received by the exchange and, thus, the order cannot be placed in the exchange queue (e.g., a matching list) and/or fulfilled. In some instances, the exchange communicates a rejection message back to the sender if the order is communicated while the exchange is closed. Therefore, a retry order is adapted to be repeatedly communicate to the exchange until the exchange is open and the retry order is accepted (e.g., acknowledgment, confirmed, allowed, etc.) at the exchange. The retry rate of a retry order is often relatively high (e.g., 5000 order/s), which results in the order being accepted by the exchange right after the exchange opens (e.g., 100 ms after the exchange opens).

In some instances, multiple retry orders are placed by the same trading device, operator and/or firm (e.g., a brokerage firm). Each of the retry orders operates, independently to communicate repeated orders to the exchange at a relatively high rate. As a result, the amount of data (e.g., bits) transferred over the communication network or exchange link often exceeds a bandwidth limitation set and/or regulated by the exchange and/or the trading system. In some instances, the exchange may disconnect the trading system from the exchange for violation of the exchange imposed limitation. In certain instances, the exchange may penalize a trading system that exceeds a message limit. In certain instances, the exchange may establish another type of incentive (or, in some configurations, disincentive) mechanism designed to encourage compliance with the limitations and/or regulations established by the exchange. Additionally or alternatively, the trading system may not function properly or become inoperative (e.g., due to a system crash from overloading the system).

The systems and methods disclosed herein manage or control the communication of one or more retry orders to prevent the retry orders from exceeding a bandwidth limitation while still enabling the retry orders to gain a favorable queue position at an exchange. A bandwidth limitation may be imposed, for example, by an exchange and/or an electronic trading system and may limit a number of orders and/or network traffic permitted at one time by the exchange and/or the trading system. Different exchanges may impose different bandwidth limitations. For example, the exchange limit of the Chicago Mercantile Exchange (CME) is around five hundred (500) operations per second. On the other hand, the exchange limit of the Tokyo Commodities Exchange/Tokyo Financial Exchange (TOCOM/TFX) is around five (5) operations per second. The example systems and methods disclosed herein may be implemented to adjust the behavior of the retry orders to prevent the retry orders from exceeding the bandwidth limitation if the retry orders are approaching such limitation. In some examples, the retry rates or retry intervals (e.g., the speed at which the retry orders are to be sent) of one or more of the retry orders is altered (e.g., reduced, increased). For example, an effective rate or effective interval may be implemented to control and/or regulate how often one or more of the retry orders are communicated to the exchange. In some examples, the effective rate or effective interval is based on an exchange rate or exchange interval, which corresponds to the maximum allowable rate, and/or the retry intervals of the retry orders. In some examples, one of the retry orders is selected to be repeatedly communicated to the exchange while the other retry orders are withheld, and not communicated at all. Once an acknowledgement is received from the exchange in response to one of the repeated retry orders being accepted at the exchange, the remaining retry orders are communicated to the exchange (e.g., at the maximum allowable rate or exchange rate).

In some example methods and systems disclosed herein, the retry orders are arranged or organized into a sequential order, and the retry orders are communicated to the exchange one after another in accordance with the sequential order. The retry orders may be arranged in the sequential order based on, for example, the retry intervals of respective retry orders, an exchange rate or interval (e.g., a maximum allowable rate and/or minimum allowable interval), an order in which they retry orders are received or entered, a per-operator basis and/or on a per-firm basis. In some examples, the retry orders are communicated at the effective rate or effective interval. When an acknowledgement is received from the exchange in response to one of the retry orders being accepted at the exchange, the other remaining retry orders are communicated to the exchange (e.g., at the maximum allowable rate or exchange rate). By adjusting retry order arrangement, rate, and/or interval, the example systems and methods disclosed herein enable one or more retry orders to be placed at an exchange in a favorable position without overloading the electronic trading system and/or the exchange.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

An embodiment disclosed herein provides a method including receiving, by a computing device, a plurality of retry orders, wherein each of the plurality of retry orders is defined by a first parameter that represents a retry interval. The method of the embodiment includes organizing, by the computing device, the received plurality of retry orders for communication to an exchange, wherein the organized plurality of retry orders are arranged in a sequential order based on the retry intervals of the plurality of retry orders. The method of the embodiment also includes communicating, by the computing device, each of the plurality of retry orders to the exchange according to the sequential order, receiving, by the computing device, an acknowledgement from the exchange in response to one of the plurality of retry orders sequentially communicated to the exchange and communicating, by the computing device, the remaining plurality of retry orders to the exchange in response to the received first acknowledgement.

Another embodiment disclosed herein provides a method including receiving, by a computing device, a plurality of retry orders. Each of the retry orders includes a retry interval defining an amount of time that is to occur between repeated orders of the respective retry order. The method of the embodiment includes arranging, by the computing device, the plurality of retry orders into a sequential order in which the plurality of retry orders are to be sent to an exchange and determining, by the computing device, an effective interval. The effective interval defines an amount of time that is to occur between communicating each of the plurality of retry orders in the sequential order to the exchange. The method of the embodiment also includes communicating, by the computing device, the plurality of retry orders to the exchange according to sequential order at the effective interval and determining, by the computing device, if a first retry order of the plurality of retry orders is to be communicated to the exchange in an amount of time that is less than the respective retry interval of the first retry order. The method of the embodiment also includes rearranging, by the computing device, the first retry order in the sequential order when the determined amount of time is less than the respective retry interval by moving the first retry order to a later position in the sequential order where an amount of time to occur before the first retry order is to be communicated to the exchange is substantially the same or greater than the respective retry interval of the first retry order.

In yet another embodiment disclosed herein, a method is provided including receiving, by a computing device, a first retry order and a second retry order, selecting, by the computing device, one of the first retry order or the second retry order to communicate to an exchange and communicating, by the computing device, the selected one of the first retry order or the second retry order to the exchange. The method of the embodiment also includes receiving, by the computing device, an acknowledgment from the exchange in response to the selected one of the first retry order or the second retry order communicated to the exchange and communicating, by the computing device, the other of the selected one of the first retry order or the second retry order to the exchange after receiving the acknowledgment.

An embodiment disclosed herein provides a system including a processor coupled to a memory. The processor is configured to execute instructions stored on the memory to receive a plurality of retry orders, wherein each of the plurality of retry orders is defined by a first parameter that represents a retry interval, organize the received plurality of retry orders for communication to an exchange, wherein the organized plurality of retry orders are arranged in a sequential order based on the retry intervals of the plurality of retry orders, and communicate each of the plurality of retry orders to the exchange according to the sequential order. The processor of the system is also configured to execute instructions stored on the memory to receive an acknowledgement from the exchange in response to one of the plurality of retry orders sequentially communicated to the exchange and communicate the remaining plurality of retry orders to the exchange in response to the received first acknowledgement.

Another embodiment disclosed herein provides a system including a processor coupled to a memory. The processor is configured to execute instructions stored on the memory to receive a plurality of retry orders, each of the retry orders including a retry interval defining an amount of time that is to occur between repeated orders of the respective retry order, arrange the plurality of retry orders into a sequential order in which the plurality of retry orders are to be sent to an exchange, determine an effective interval, the effective interval defining an amount of time that is to occur between communicating each of the plurality of retry orders in the sequential order to the exchange and communicate the plurality of retry orders to the exchange according to sequential order at the effective interval. The processor of the system is also configured to execute instructions stored on the memory to determine if a first retry order of the plurality of retry orders is to be communicated to the exchange in an amount of time that is less than the respective retry interval of the first retry order and rearrange the first retry order in the sequential order when the determined amount of time is less than the respective retry interval by moving the first retry order to a later position in the sequential order where an amount of time to occur before the first retry order is to be communicated to the exchange is substantially the same or greater than the respective retry interval of the first retry order.

In yet another embodiment disclosed herein, a system is provided that includes a processor coupled to a memory. The processor is configured to execute instructions stored on the memory to receive a first retry order and a second retry order, select one of the first retry order or the second retry order to communicate to an exchange, communicate the selected one of the first retry order or the second retry order to the exchange, receive an acknowledgment from the exchange in response to the selected one of the first retry order or the second retry order communicated to the exchange and communicate the other of the selected one of the first retry order or the second retry order to the exchange after receiving the acknowledgment.

An embodiment disclosed herein provides a tangible computer readable storage medium having instructions that, when executed, cause a processor to receive a plurality of retry orders, wherein each of the plurality of retry orders is defined by a first parameter that represents a retry interval, organize the received plurality of retry orders for communication to an exchange, wherein the organized plurality of retry orders are arranged in a sequential order based on the retry intervals of the plurality of retry orders, and communicate each of the plurality of retry orders to the exchange according to the sequential order. The instructions of the tangible computer readable storage medium also cause, when executed, the processor to receive an acknowledgement from the exchange in response to one of the plurality of retry orders sequentially communicated to the exchange and communicate the remaining plurality of retry orders to the exchange in response to the received first acknowledgement.

Another embodiment disclosed herein provides a tangible computer readable storage medium having instructions that, when executed, cause a processor to receive a plurality of retry orders, each of the retry orders including a retry interval defining an amount of time that is to occur between repeated orders of the respective retry order, arrange the plurality of retry orders into a sequential order in which the plurality of retry orders are to be sent to an exchange, determine an effective interval, the effective interval defining an amount of time that is to occur between communicating each of the plurality of retry orders in the sequential order to the exchange, and communicate the plurality of retry orders to the exchange according to sequential order at the effective interval. The instructions of the tangible computer readable storage medium also cause, when executed, the processor to determine if a first retry order of the plurality of retry orders is to be communicated to the exchange in an amount of time that is less than the respective retry interval of the first retry order and rearrange the first retry order in the sequential order when the determined amount of time is less than the respective retry interval by moving the first retry order to a later position in the sequential order where an amount of time to occur before the first retry order is to be communicated to the exchange is substantially the same or greater than the respective retry interval of the first retry order.

In yet another embodiment disclosed herein, a tangible computer readable storage medium is provided that has instructions that, when executed, cause a processor to receive a first retry order and a second retry order, select one of the first retry order or the second retry order to communicate to an exchange, communicate the selected one of the first retry order or the second retry order to the exchange, receive an acknowledgment from the exchange in response to the selected one of the first retry order or the second retry order communicated to the exchange and communicate the other of the selected one of the first retry order or the second retry order to the exchange after receiving the acknowledgment.

### II. Example Electronic Trading System

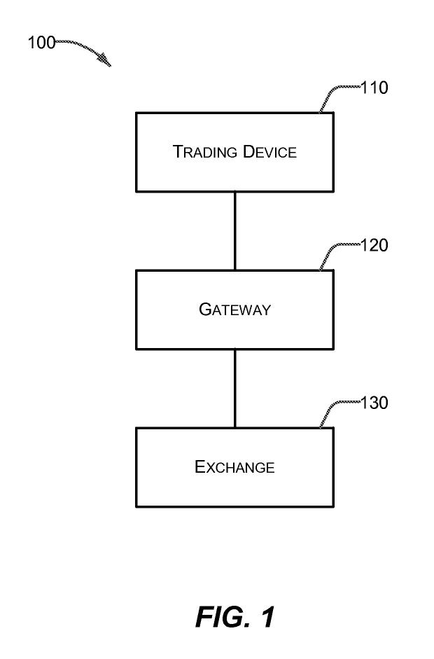

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

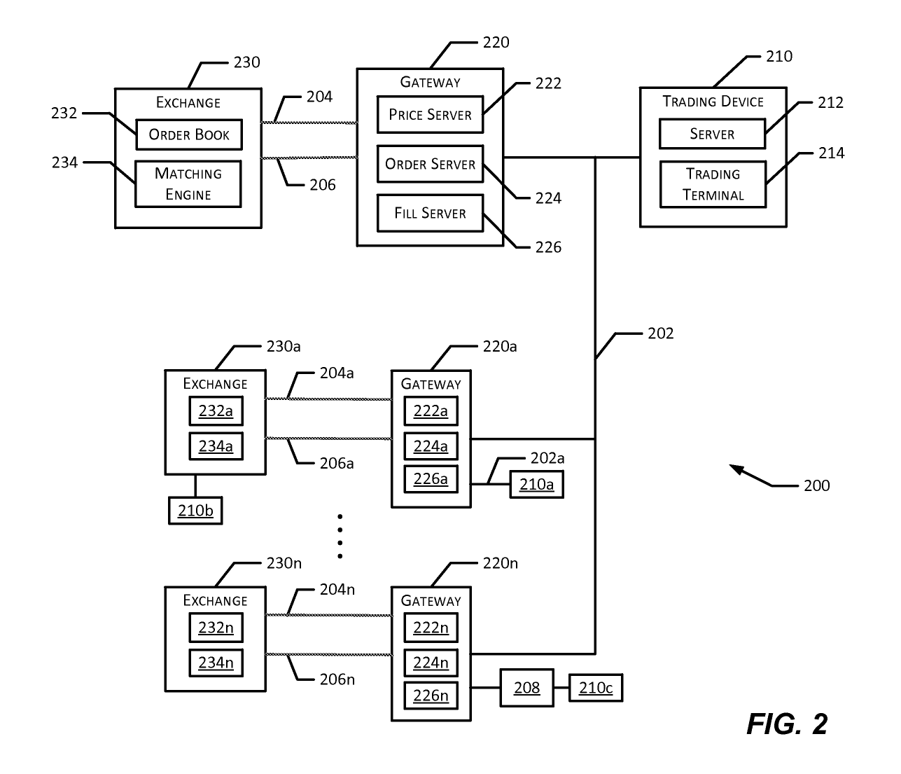

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

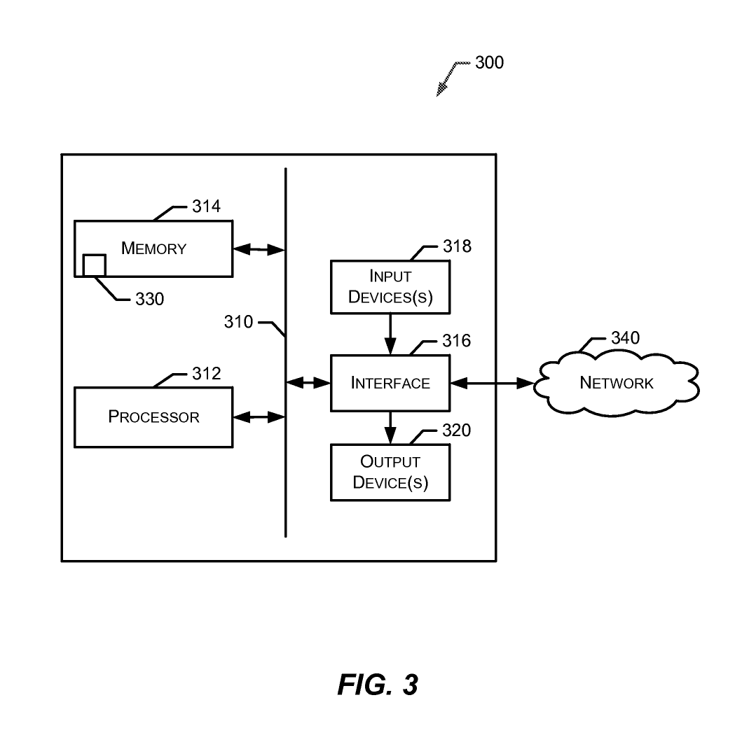

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Example Trading System for Communicating One or More Retry Orders

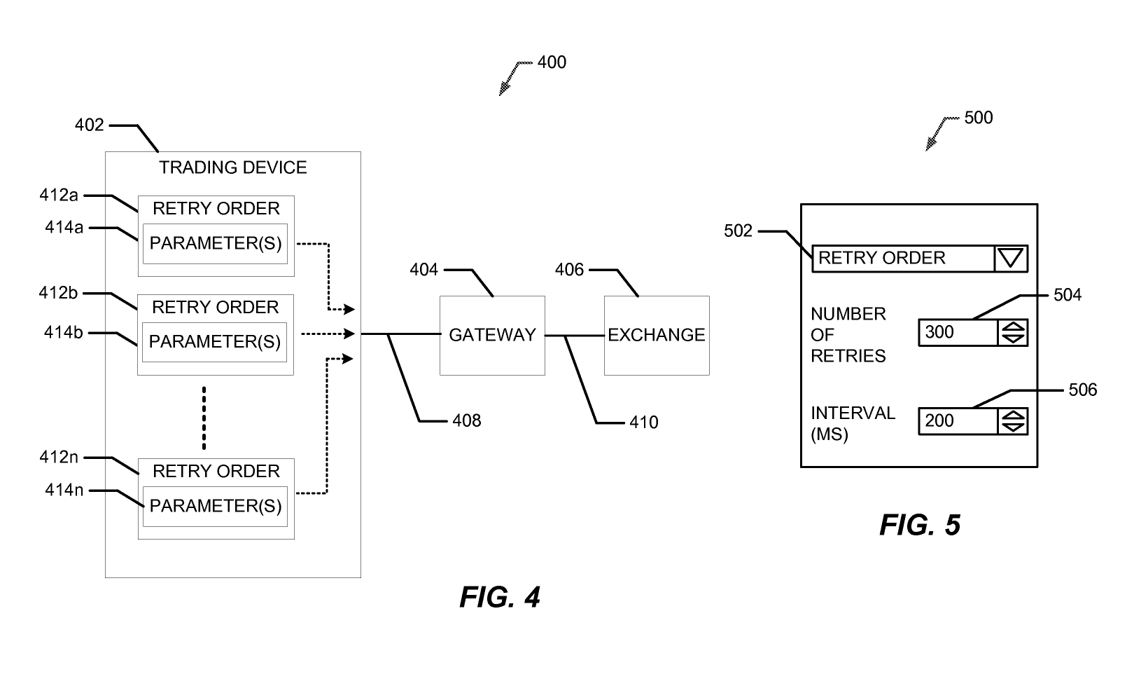

FIG. 4 illustrates a block diagram an example electronic trading system 400 in which certain embodiments may be employed. The electronic trading system 400 may be similar to the trading system 100 and/or the trading system 200, for example. The system 400 includes a trading device 402, a gateway 404 and an exchange 406. The trading device 402, the gateway 404 and/or the exchange 406 may correspond to, for example, one or more of the example trading devices 110, 210, 210a, 210c, the example gateways 120, 220, 220a, 220n, and/or the example exchanges 130, 230, 230a, 230, respectively, of FIGS. 1 and 2. Similar to the above-disclosed embodiments, the electronic trading system 400 may utilize one or more communication networks or exchange links to communicate with the gateway 404 and the exchange 406. For example, the trading device 402 utilizes a network 408 to communicate with the gateway 404, and the gateway 404, in turn, utilizes a network 410 to communicate with the exchange 406.

In the illustrated example, the trading device 402 has a first retry order 412a that is to be communicated (e.g., sent, transmitted, submitted, etc.) to the exchange 406. The first retry order 412a (e.g., a parent order) is a type of order for a tradeable object that includes one or more associated parameters that enable the first retry order 412a to be repeatedly communicated to the exchange 406 to obtain a favorable position in the queue of the exchange 406 once the exchange 406 opens. The first retry order 412a may be placed just prior to the opening of the exchange 406 (e.g., the opening of the market, the start of a trading session). The first retry order 412a is repeatedly sent to the exchange 406 until it is accepted at the exchange 406. As a result, the first retry order 412a can be fulfilled and/or added to a queue at the exchange 406 shortly after the exchange 406 is open (e.g., 100 ms after the exchange 406 is open).

In the illustrated example, the first retry order 412a includes one or more parameters 414a associated with the first retry order 412a. The parameter(s) 414a of the first retry order 412a may include, for example, an identification of a tradeable object, a price for the tradeable object, a quantity of the tradeable object, slop parameters, pay-up ticks, a start date and/or time, a number of retries, a retry interval and/or a retry rate. A retry interval, as disclosed herein, defines the interval of time that is to occur before a retry order is repeated or resent to the exchange. A retry rate, as disclosed herein, is based on the retry interval and defines the number of times the retry order is to be sent to the exchange in a defined period of time (e.g., one second). Therefore, the parameters 414a of the first retry order 412a enable the first retry order 412a to be to be repeatedly communicated to the exchange 406 until the first retry order 412a is accepted at the exchange 406.

FIG. 5 illustrates an example screen or window 500 (e.g., a trading tool, an order pane) that may be implemented to place or enter the first retry order 412a on a graphical user interface. The example window 500 includes a dropdown menu 502 to specify a type of order. In the illustrated example, the type of order 502 has been specified as a retry order. Thus, certain parameters (e.g., the parameter(s) 414a of the first retry order 412a) are associated with the first retry order 412a. The example window 500 includes a first modifier 504 (e.g., an option) to specify the maximum number of retries or retry attempts (e.g., a retry number). For example, if the first modifier 504 is set to three hundred (300), the first retry order 412a is to be sent to the exchange 406 up to three hundred (300) times. In the illustrated example, the example window 500 includes a second modifier 506 to specify a retry interval, which defines or specifies the amount of time to occur between each resubmission attempt of the first retry order 412a. Additionally, a retry rate may be determined based on the specified retry interval. For example, if the retry interval is set at two hundred (200) ms, the resulting retry rate is five orders per second (5 orders/s). In other words, every two hundred (200) ms, the first retry order 412a is communicated to the exchange 406. In other examples, more or fewer identifiers or modifiers (e.g., parameters) are included in the window 500 to modify different parameters for the first retry order 412a (e.g., a modifier to specify the start time and/or date).

By way of example, the parameter window 500 may be implemented on the trading device 402 and/or the gateway 404 by a trading platform or trading application such as, for example, X_TRADER®, ADL®, AUTOSPREADER®, and/or AUTOTRADER™, as disclosed herein. An example parameter window 500 is the Retry Order Pane, provided by Trading Technologies, that allows users to enter modifiers or parameters such as those disclosed above.

In the illustrated example, the first retry order 412a is to be communicated to the exchange 406 repeatedly (in accordance with the first parameter(s) 414a). The trading device 402 attempts to send another one of the first retry order 412a to the exchange 406 at every retry interval of the retry order 412a. In some examples, the trading device 402 does not attempt to communicate another one of the first retry order 412a until a rejection message has been received from the exchange 406. As a result, multiple orders of the first retry order 412a are not inadvertently added to the queue at the exchange 406. The trading device 402 repeatedly attempts to send the first retry order 412a to the exchange 406 until an acknowledgment is received from the exchange 406 or the number of retries (e.g., the max retry count) is met.

In the illustrated example, the trading device 402 has a plurality of retry orders 412a-412n that are to be sent to the exchange 406. Each of the retry orders 412b-412n may be similar to the first retry order 412a and may have one or more associated parameter(s) 414a-412n that include, for example, an identification of a tradeable object, a price for the tradeable object, a quantity of the tradeable object, slop parameters, pay-up ticks, a start date and/or time, a number of retries, a retry interval and/or a retry rate. In other examples, other parameters may be included that define the behavior the respective retry orders 412a-412n.

As disclosed herein, the trading device 402 may be implemented using the computer device 300 described above. For example, the trading device 402 may be one or more of a desktop computer, hand-held device, laptop, server, a portable computing device, a trading terminal, an embedded trading system, a workstation, an algorithmic trading system such as a “black box” or “grey box” system, cluster of computers, or a combination thereof. One or more users (e.g., operators) may enter one or more of the retry orders 412a-412n. For example, one operator may enter or place multiple one or more of the retry orders 412a-412n on a desktop computer for different tradeable objects at the exchange 406. In other examples, the trading device 402 is a server and one or more of the retry orders 412a-412n may be entered or placed by one or more operators (e.g., on desktop computer(s)) that are in communication with the server.

Prior to the opening of the exchange 406 (e.g., the start of a trading session), the trading device 402 and/or the gateway 404 communicates or sends the retry orders 412a-412n to the exchange 406 in accordance with respective parameters 414a-414n. In other words, each of the retry orders 412a-412n operates independently and is repeatedly sent or communicated to the exchange 406 in an effort to be accepted by the exchange 406 at the opening of the exchange 406. However, because the retry orders 412a-412n are simultaneously sending order messages to the exchange 406 (and receiving rejection messages back from the exchange 406), the amount of information transmitted across the networks 408, 410 may exceed capacity limitations (e.g., bandwidth limits) set and/or regulated by, for example, the exchange. Additionally or alternatively, bandwidth limits may be set and/or regulated by the electronic trading system 400 (e.g., via the gateway 404). For example, the gateway 404 may include a bandwidth limiter (e.g., a “throttle”) to prevent the trading device 402 from transmitting/receiving too much data. As a result, in some examples the trading device 402 and/or the gateway 404 are disconnected from the exchange 406 for violating or exceeding the imposed bandwidth limits. Additionally or alternatively, in some examples, the trading device 402 and/or the gateway 406 may stop functioning properly or become inoperative (e.g., due to a system crash). In such an instance, the retry orders 412a-412n are not able to be entered at the opening of the exchange 406 and the system 400 may be inoperative for a period of time (e.g., a few hours, a day, etc.).

### VI. Adjustment of Retry Order Behavior

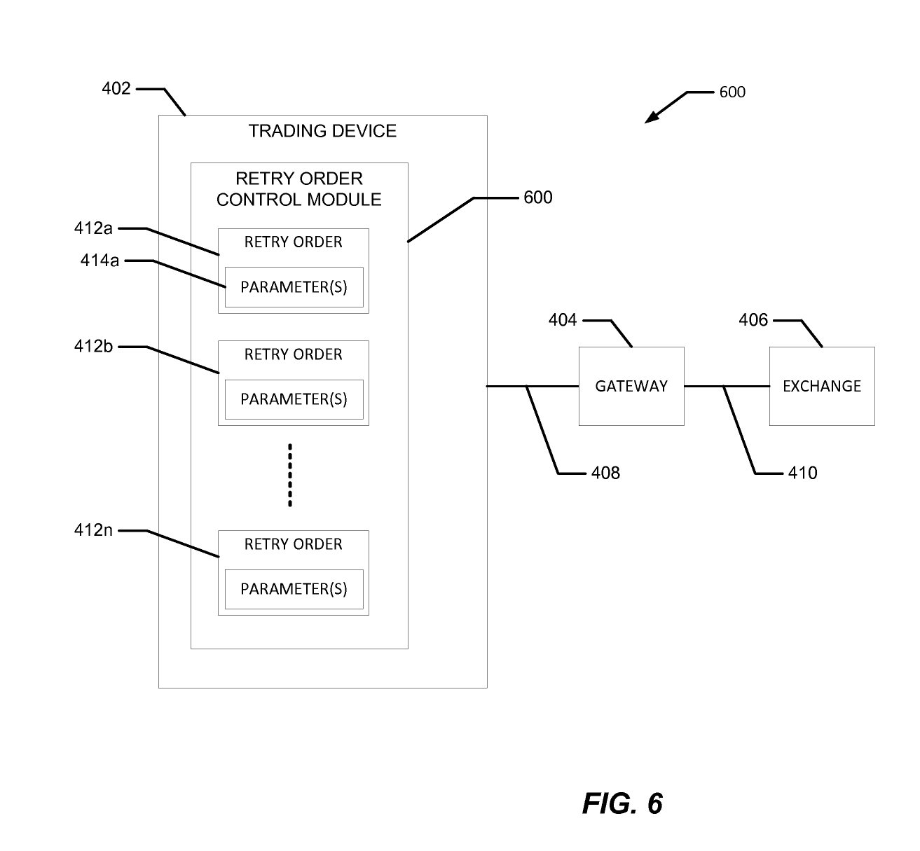

FIG. 6 illustrates another example electronic trading system 600 described herein. Those components of the electronic trading system 600 that are substantially similar or identical to the components of the electronic trading system 400 described above and that have functions substantially similar or identical to the functions of those components will not be described in detail again below. Instead, the interested reader is referred to the above corresponding descriptions. To facilitate this process, the same reference numbers will be used for like structures.

In the illustrated example of FIG. 6, the trading device 402 includes a retry order control module 600 capable of implementing one or more of the embodiments of this disclosure. The retry order control module 600 is to manage or control the operation of the retry orders 412a-412n being sent from the trading device 402 and/or the gateway 404 to the exchange 406. In particular, the retry order control module 600 is adapted to detect when system 600 is approaching bandwidth limitation(s) (e.g., limitation(s) imposed by the exchange 406 and/or by the system 600) and adjust the behavior of the retry orders 412a-412n to prevent an overloading of the system 600. More specifically, the control module 600 is to change (e.g., reduce) the retry rate at which one or more of the retry orders 412a-412n is to be sent to the exchange 406 and/or create a sequence in which one or more of the retry orders 412a-412n is sent to the exchange 406. Example methods for detecting when a system is approaching an exchange limit are disclosed in U.S. application Ser. No. 13/718,949, titled “Methods and Systems to Prevent Adverse Exchange Limit Effects,” filed Dec. 18, 2012, the content of which is incorporated herein by reference in its entirety.

The control module 600 may be implemented as part of software (or an application) associated with the trading device 402 and/or the gateway 404. In some examples, the control module 600 may be implemented as computer implemented code or instructions operable independent of software associated with the trading device 402 and/or the gateway 404. In some examples, the features and functionality of the control module 600 may be implemented in hardware operable in connection with the trading device 402 and/or the gateway 404.

A. Single Retry Order Communication Example

In one example operation, the one of the retry orders 412a-412n is selected to be communicated to the exchange 406 while the other retry orders 412a-412n are withheld from communicating to the exchange 406. When an acknowledgement or confirmation is received from the exchange 406 in response to the selected one of the retry orders 412a-412n being accepted at the exchange 406, the control module 600 recognizes that the exchange is open and communicates the remaining retry orders 412a-412n to the exchange. In some examples, the remaining retry orders 412a-412n are communicated to the exchange 406 at a maximum exchange rate or minimum exchange interval (e.g., the maximum allowable rate or minimum allowable interval). As a result, the control module 600 prevents the plurality of retry orders 412a-412n from sending a relatively large amount of message orders to the exchange 406. Using a single “test” retry order, the control system 600 prevents the plurality of retry orders 412a-412n from exceeding a bandwidth limitation(s) (e.g., an exchange imposed limitation and/or a system imposed limitation on number of orders allowed and/or other network traffic permitted) and crashing the system (in which case no orders can be communicated) while still enabling the retry orders 412a-412n to be sent to the exchange 406 at the very beginning or opening of the exchange 406. In some examples, the selection of the one of the retry orders 412a-412n to communicate to the exchange 406 may be random. In other examples, the selection is based on user input (e.g., an operator manually selects one of the retry orders 412a-412n).

For example, the control module 600 may select the first retry order 412a to communicate to the exchange 406. Just prior to the opening of the exchange 406, the control module 600 begins repeatedly sending the first retry order 412a to the exchange 406. In some examples, the trading device 402 begins sending the first retry order 412a to the exchange 406 at the start date and/or time defined or specified by the associated parameter(s) 414a of the first retry order 412a. In other examples, the trading device 402 may select a different start time to begin communicating the first retry order 412a. In some examples, the first retry order 412a is communicated to the exchange 406 at a retry rate or retry interval defined or specified by the associated parameter(s) 414a. In other examples, the control system 600 detects an exchange rate or exchange interval (e.g., a maximum exchange rate or allowable, a minimum exchange interval or allowable interval) and sends the first retry order 412a at the exchange rate or exchange interval. Therefore, an effective rate or effective interval at which the first retry order 412a is to be sent to the exchange is set at the lower of the exchange rate or the retry rate (or the higher of the exchange interval or the retry interval) associated with the first retry order 412a.

In some examples, while the first retry order 412a is being repeatedly communicated to the exchange 406, the other retry orders 412b-412n are not executed and, thus, are not sent to the exchange 406 simultaneously as the first retry order 412a. As a result, the control module 600 prevents the retry orders 412a-412n from operating independently and simultaneously, which typically causes the system 400 to exceed bandwidth limitations.

Prior to the opening of the exchange 406, the orders or order messages sent to the exchange 406 are not accepted or received by the exchange 406. In some examples, a rejection message is sent back to the trading devisee 402 and/or the gateway 404 that indicates that the respective retry order was not accepted at the exchange 406. Once the exchange 406 opens (e.g., at the start of a trading session), the first retry order 412a is accepted and placed into the queue at the exchange 406. As disclosed herein, the first retry order 412a may be placed on a matching list of a matching engine. The trading device 402 receives an acknowledgement from the exchange 406 that the order has been accepted or confirmed at the exchange 406. The example control module 600 then communicates the remaining retry orders 412b-412n to the exchange 406, where they are also be accepted because the exchange 406 is now open. In some examples, the remaining retry order 412b-412n are communicated at the exchange rate or exchange interval.

B. Multiple Retry Order Sequencing Example

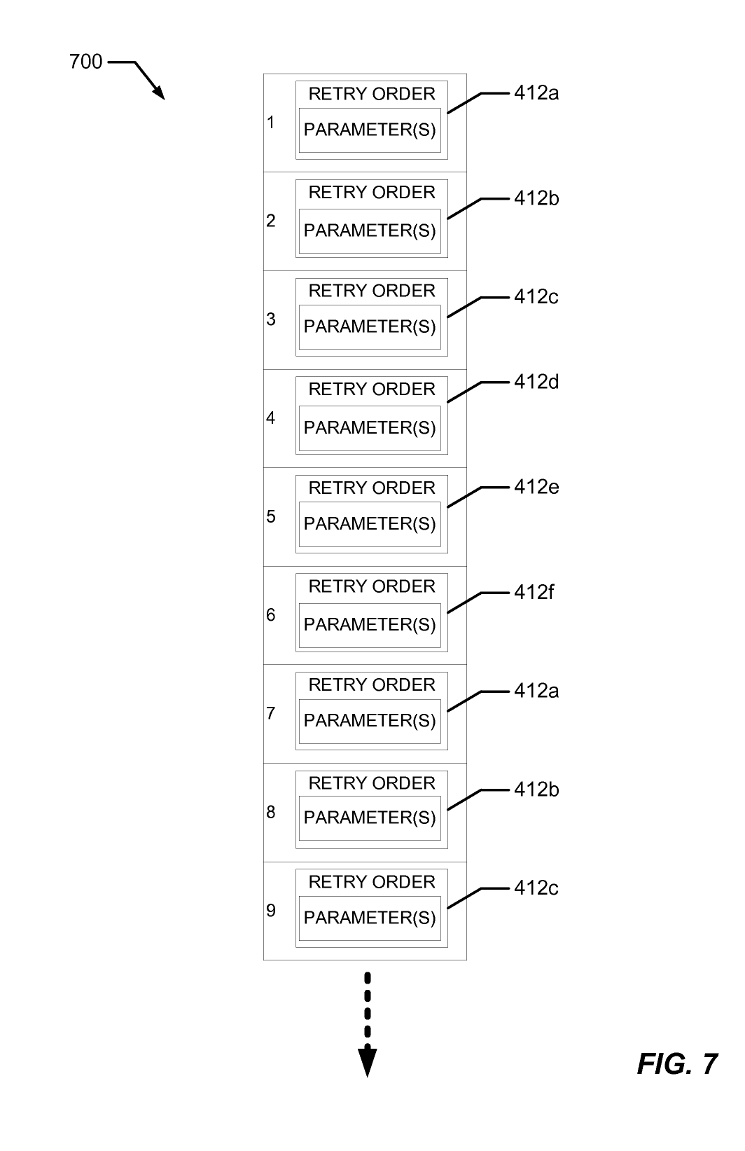

In another example operation, the control module 600 arranges or organizes (e.g., interlaces) the retry orders 412a-412n into a sequential list or order and communicates the retry orders 412a-412n one at a time in accordance with the sequential order. FIG. 7 illustrates an example list or sequential order 700. For purposes of demonstration, an example process is disclosed herein with six retry orders 412a-412f. However, it is understood that the example sequencing may be implemented with more or fewer retry orders (e.g., 3 retry order, 500 retry orders, 20,000 retry orders, etc.) The example control module 600 arranges the retry orders 412a-412f into the sequential order 700. The retry orders 412a-412f may be arranged in accordance with different protocols disclosed herein.

In the illustrated example, the sequential order 700 repeats the succession (e.g., cycle, sequence) of the retry orders 412a-412f over and over. For example, the first retry order 412a is in the first position or spot in the order 700, the second retry order 412b is in the second position or spot in the order 700, the third retry order 412c is in the third position or spot in the order 700, the fourth retry order 412d is in the fourth position or spot in the order 700, the fifth retry order 412e is in the fifth position or spot in the order 700 and the sixth retry order 412f is in the sixth position or spot in the order 700. After all of the retry orders 412a-412f have been placed in the respective positions (e.g., interlaced, placed in round robin arrangement), the sequential order 700 continues by repeating the same succession or cycle of the retry orders 412a-412f. In other words, after each of the retry orders 412a-412f is sent to the exchange 406, the respective retry orders 412a-412f are moved to the back of the succession. Thus, the sequential order 700 repeats the succession of the retry orders 412a-412f. For example, the first retry order 412a is in seventh position or spot in the order 700, the second retry order 412b is in the eighth position or spot in the order 700, the third retry order 412c is in ninth position or spot in the order 700, and so forth. The sequential order 700 represents the order in which the retry orders 412a-412f are to be sent to the exchange 406. If new orders are entered or placed while the retry orders 412a-412f are being communicated to the exchange 406, the new orders may be placed at the back of the succession of the retry orders 412a-412f and the entire succession may be repeated over and over.

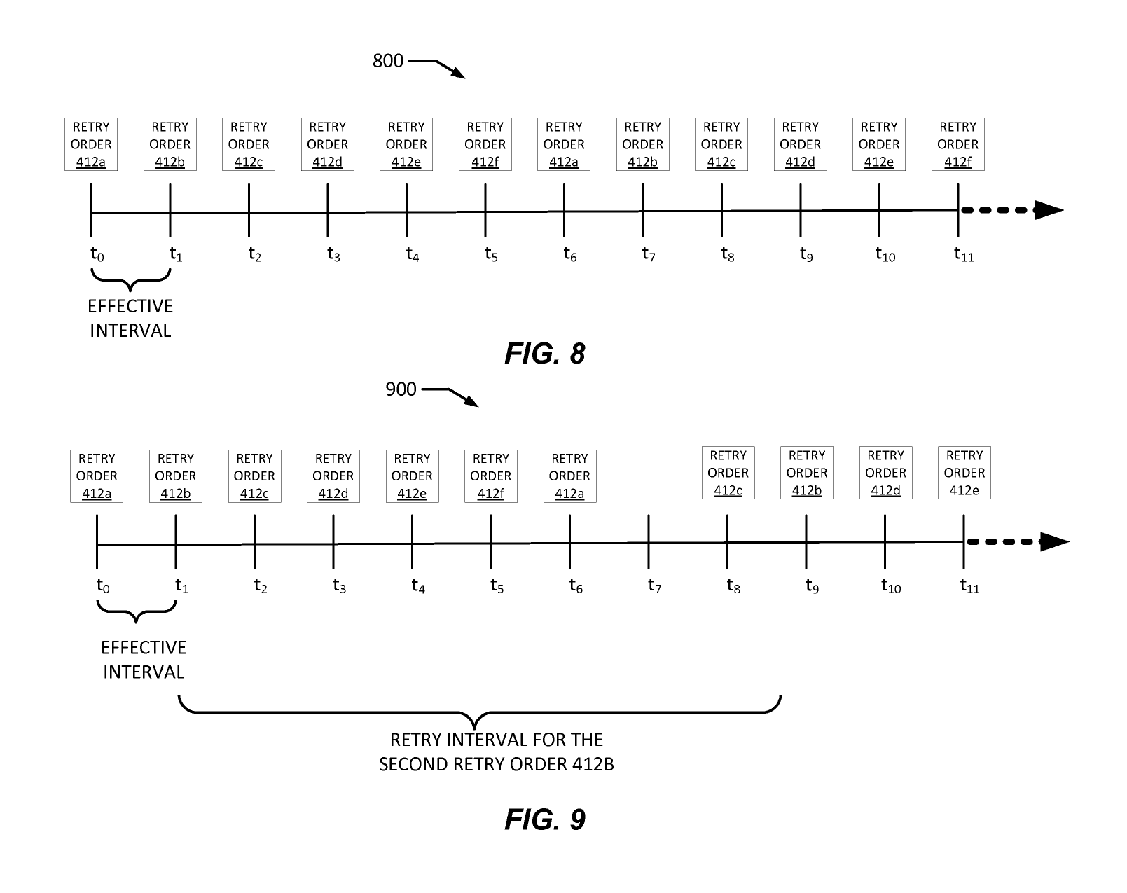

FIG. 8 illustrates an example timing diagram or timeline 800 during which the retry orders 412a-412f are communicated to the exchange 406 in the sequential order 700. As illustrated, one of the retry orders 412a-412f is communicated to the exchange at every interval t, starting with t₀. The time between each one of the communications is defined as an effective interval. In some examples, the effective interval is set at the exchange interval (e.g., the minimum allowable interval). For example, the exchange rate may be ten (10) orders or order messages per second, which results in an exchange interval of 100 ms. If more orders or order messages are sent in one second (or with a smaller interval), the system 400 may exceed a bandwidth limitation. Therefore, in some examples, the effective rate at which the retry orders 412a-412f are to be sent to the exchange 406 is set at the exchange rate (e.g., 10 orders/s), which is the maximum allowable rate. Thus, the effective interval, which defines the time between the retry orders 412a-412f, is 100 ms. For example, the first retry order 412a is sent or communicated at t₀, the second retry order 412b is sent or communicated 100 ms later at t₁, the third retry order 412c is sent or communicated at 100 ms later at t₂, and so forth. In other words, the third retry order 412c is sent 100 ms after the second retry order 412b was sent at t₁ and 200 ms after the first retry order 412a was sent at t₀. This pattern continues as the retry orders 412a-412f are communicated to the exchange 406 at the effective interval.

Once the exchange 406 opens for trading, one of the retry orders 412a-412f that is sent to the exchange 406 is accepted at the exchange 406. An acknowledgment that the one of the retry orders 412a-412f was accepted or confirmed at the exchange 406 is sent back to the trading device 402 and/or gateway 404. The control module 600 recognizes that the exchange 406 is open and the remaining retry orders 412a-412f (not including the one of the retry orders 412a-412f that was already accepted at the exchange 406) are communicated to the exchange 406, which is open and, thus, the orders are accepted at the exchange 406. For example, if the second retry order 412b was communicated at time t7 and an acknowledgement was received from the exchange 406, the other retry orders 412a, 412c-412f are communicated to the exchange 406. In some examples, the remaining retry orders 412a, 412c-412f are communicated at the exchange rate (e.g., the maximum allowable rate). For example, if the exchange rate was 10 orders/s, then all of the remaining five retry orders 412a, 412c-412f could be communicated substantially simultaneously without exceeding the bandwidth limitations. In this manner, the retry orders 412a-412f do not overload the system 600 by competing with each other, but instead use the accepted one of the retry orders 412b (e.g., a “scout”) to signal that the exchange 406 is open, at which point all of the remaining orders 412a, 412c-412f can be communicated without the risk of exceeding bandwidth limitations.

In some examples, the effective interval at which the retry orders 412a-412f are communicated to the exchange is faster than the time it takes to receive a rejection message or acknowledgment message from the exchange 406. For example, referring to the timeline 800, the first retry order 412a may be sent at t₀, the second retry order 412b may be sent at time t₁, the third retry order 412c may be sent at t₂, and then a rejection message corresponding to the first retry order 412a sent at t₀ may be received sometime between t₂ and t₃. Thus, in some examples the retry orders 412a-412f may be communicated before receiving a rejection message from the previous communication. As a result, the retry orders 412a-412f are communicated faster than other systems that may require waiting until a rejection message is received before communicating a next retry order.

In another example operation, the retry orders 412a-412f are arranged or organized based on the retry intervals of the retry orders 412a-412f. For example, the effective interval and/or the effective rate may be based on the smallest retry interval (which corresponds to the highest retry rate) of the retry orders 412a-412f. Once the smallest retry interval is identified, the control module 600 calculates the effective rate by dividing the total number of retry orders (e.g., six) by the identified lowest retry interval. In this manner, the effective rate enables the retry order with the lowest retry interval to be communicated at its same respective retry interval. As a result, the retry order with the smallest interval is not slowed down (e.g., communicated at an interval that is less than its retry interval) caused by the sequencing. However, all of the other retry orders 412a-412f are also, consequently, communicated at this same retry rate or retry interval. Therefore, if one of the retry orders 412a-412f has a retry rate that is slower than the fastest retry rate of the retry orders, the retry rate or interval of that retry order 412a-412f would be violated (e.g., which may result in exchange penalties or fines), because it would be communicated faster or more often than allowed by its corresponding retry rate or retry interval. In this scenario, the control module 600 detects if one of the retry orders 412a-412f is to be communicated in an amount of time that is less than the associated retry interval and rearranges or adjusts the sequential order 700. In some examples, the one of the retry orders 412a-412f is moved to a position in the sequential order 700 that results in the amount of time being about equal to or greater than retry interval of the respective one of the retry orders 412a-412f.

For purposes of demonstration, an example of the repositioning operation is disclosed. Table 1 illustrates an example of retry rates and retry intervals for the retry orders 412a-412f.

TABLE 1

| Retry Order | Retry Rate (orders/second) | Retry Interval (ms) |
|---|---|---|
| 412a | 10 | 100 |
| 412b | 8.33 | 120 |
| 412c | 10 | 100 |
| 412d | 10 | 100 |
| 412e | 10 | 100 |
| 412f | 10 | 100 |

As illustrated in Table 1, the first retry order 412a, the third retry order 412c, the fourth retry order 412d, the fifth retry order 412e and the sixth retry order 412f have the same retry rate and retry interval, which is the fastest retry rate of 10 orders/s or the smallest retry interval of 100 ms. After identifying the smallest retry interval of the retry orders 412a-412f, the effective rate is calculated by dividing the total number of orders to be sequenced (i.e., six in this example) by the identified smallest retry interval (i.e., 100 ms). Thus, the effective rate is 6 orders/100 ms or 60 orders/s, and the effective interval is 0.017 s or 17 ms.

FIG. 9 illustrates an example timing diagram or timeline 900 during which the retry orders 412a-412f are communicated to the exchange 406 and one or more of the retry order 412a-412f are moved in the sequential order 700 in accordance with the embodiments disclosed herein. As illustrated, the first retry order 412a is communicated at t₀, the second retry order 412b is communicated 17 ms later at t₁, and so forth. At t₆, all of the retry orders 412a-412f have been communicated once, initially, to the exchange 406. As illustrated in the example sequential list 700, the sequence repeats itself and the first retry order 412a is communicated at t₆. The time between t₀ and t₆ is 100 ms, which is equal to the retry interval 100 ms of the first retry order 412a. As such, the timing parameters for the first retry order 412a are not been violated when the first retry order 412a is resent to the exchange 406 at time t₆.

In accordance with the sequential order 700, the second retry order 412b is to be communicated next at t₇. However, the time between t₁, when the second retry order 412b was previously sent, and t₇, when the second retry order 412b is to be resent, results in an interval of time of 100 ms, which is less than the retry interval of 120 ms for the second retry order 412b (Table 1). As a result, sending the second retry order 412b to the exchange 406 at this time would violate the parameters set or defined by the user for the second retry interval 412b. In this instance, the control module 600 is adapted to move or reposition the second retry order 412b to a later or subsequent position in the sequential order that results in a total interval time that is about equal to or greater than the retry interval of 120 ms of the second retry order 412b. By moving or otherwise repositioning the second retry order 412b, the second retry interval of the second retry order 412b is not violated and the second retry order 412b can be communicated as soon as its respective retry interval allows, without losing a turn or cycle in the sequential order 700. As such, the second retry order 412b is not inadvertently punished for having a relatively lower retry rate or larger retry interval.

For instance, in the illustrated example of FIG. 9, the second retry order 412b is moved to a position that is to be communicated at t₉. The time between t₁, when the second retry order 412b was previously sent, and t₉, when the second retry order 412b is to be sent again, results in an interval of 134 ms, which is greater than the retry interval of 120 ms for the second retry order 412b. This process continues as the retry orders 412a-412f are communicated one after another in accordance with the sequential order 700. In other words, the control module 600 continues to verify that the respective retry interval of each of the retry orders 412a-412f is not violated. In the illustrated example, when the second retry order 412b is rearranged or moved to be communicated at t₉, the remaining retry orders 412a-412f of the sequential order 700 occurring after the second retry order 412b are not moved up a position in the sequential order 700. Thus, in some examples, none of the retry orders 412a-412f are communicated at t₇. However, in other examples, the remaining retry orders 412a-412f in the sequential order 700 may be shifted up one position, so that a different one of the retry orders 412a, 412c-f may be communicated at t7 (e.g., if the associated retry interval is not violated). Additionally, as illustrated, when the second retry order 412b is rearranged or moved to be communicated at t₉, all of the remaining retry orders 412a-412f in the sequential list 700 are shifted or moved one position later in the sequential order 700. In other words, the third retry order 412d, which was supposed to be communicated at t₉, is shifted down one position and is communicated at t₁₀, and so forth.

In the above-illustrated example, the sequential order 700 is therefore based on the retry intervals of the retry order 412a-412f. However, if the effective interval is set at the exchange interval (e.g., because the exchange interval is smaller than the desired interval), a similar operation may be performed to arrange the retry orders 412a-412f into the sequential order 700 and/or reposition or move any of the retry orders 412a-412f (e.g., if a retry interval of one of retry orders 412a-412f is to be violated). In some examples, the calculations involved in repositioning or moving one or more of the retry orders 412a-412f is preformed when generating the sequential order 700 and, thus, the retry orders 412a-412f are arranged in the sequential order 700 based on the retry intervals of the retry orders 412a-412f and/or the exchange interval. In other examples, the sequential order 700 generated, and then the sequential order 700 may be adjusted as each of the retry orders 412a-412f is to be communicated.

Referring back to the sequential order 700 illustrated in FIG. 7, the sequential order can be based on different factors. In some examples, the sequential order 700 is a serial communications order (e.g., is based on the time in which each of the respective retry orders 412a-412f were placed entered). For example, if the first retry order 412a was placed or entered at the trading device 402 first, prior to the remaining retry orders 412b-412f, then the first retry order 412a is arranged in the first position or spot in the sequential order 700. Using a “per-order” arrangement, the control module 600 ensures the retry orders 412a-412f are arranged in a relatively fair manner (e.g., based on the order of receipt).

In some situations, however, a specific operator or user may place or enter the same retry order multiple times in an effort to have that retry order communicated more times during the sequential order than the other retry orders, which circumvents the intended sequencing process. Therefore, in some examples, the sequential order 700 is based on a “per-user” or “per-operator” basis. In such an example, a first retry order from a first operator is placed in the first position, a first retry order from a second operator is placed in the second position, and so forth. After one retry order from each operator has been placed sequenced, a second retry order from each of the operators is sequenced, and so forth. The “per-order” arrangement and the “per-operator” arrangement can also be combined, such that the first retry order of the first operator is the retry order that was placed or received by the first operator, and so forth.

In some situations, however, even this process may be circumvented where a firm (e.g., a trading firm) has multiple users or operators that place the same retry order in an effort to have the retry order communicated relatively more times during the sequencing than other retry orders. Therefore, in some examples, the sequential order is based on a “per-firm” basis. In such an example, a retry order from a first firm (and/or from a first operator at the first firm) is sequenced in the first position, a first retry order from a second firm (and/or from a first operator at the second firm) is sequenced in the second position, and so forth. The “per-order” arrangement, the “per-operator” arrangement and/or the “per-firm” arrangement may be combined to ensure fairness among the retry orders.

In some examples, one or more non-retry orders (e.g., hedge orders, children of synthetic stops, etc.) that are placed at the trading device 402 are arranged at the beginning of the sequential order 700. For example, the control module 600 may determine if there are any non-retry orders received at the trading device 402 and arrange the non-retry orders at the beginning of the sequential order 700. Then, when the sequential order 700 is to be communicated to the exchange 406, the non-retry orders are communicated first. If an acknowledgment is received in response to one of the non-retry orders being accepted at the exchange 406, the remaining non-retry order and/or the retry orders 412a-412f are communicated in accordance with the examples disclosed herein. By arranging the non-retry orders at the beginning of the sequential order 700, the retry orders 412a-412f are able to more effectively utilize the communication network or exchange link at the maximum rate (e.g., the effective rate) without jeopardizing the performance of other orders (e.g., an order that is working on a contract that is already open).

In some examples, as disclosed herein, the same or identical retry order may be placed multiple times (e.g., in an attempt to stack the sequential order 700 with more chances of having the respective retry order communicated and accepted at the exchange 406). In some examples, if an acknowledgment is received that a certain retry order has been accepted at the exchange 406, the control module 600 cancels the other retry orders in the set of identical retry orders. In some examples, cancelling the repeated identical retry orders readjusts or repositions the remaining retry orders in the sequential order by the remaining retry order up in the sequential order (e.g., to an earlier position in the sequential order). For example, identical retry orders (or a set of identical retry orders) may be linked or associated (e.g., via metadata), so that when one of the identical retry orders is accepted at the exchange, the remaining identical retry orders can be cancelled and the remaining retry orders are adjusted, so that the remaining retry orders may be communicated to the exchange 406 relatively sooner.

In some examples, the control module 600 should receive permission from the users or operators that placed the retry orders 412a-412f to implement one or more embodiments disclosed herein. For example, prior to altering a rate at which one or more retry orders 412a-412f is to be communicated, withholding one or more of the retry orders 412a-412f, arranging the one or more retry orders 412a-412f in a sequence or otherwise adjusting the behavior of the retry orders 412a-412f, the control module 600 is to receive permission from the users or operators that placed or entered the respective retry orders 412a-412f. In some examples, the users or operators may be prompted when entering the respective retry orders 412a-412f for permission to alter the behavior of the respective retry orders 412a-412f.

In some examples, not all of the retry orders 412a-412f are for the same exchange. For example, one or more of the retry orders 412a-412f may be for a tradeable object at one exchange (e.g., the exchange 230 of FIG. 2) and one or more of the retry orders 412a-412f may be for a tradeable object at another exchange (e.g., the exchange 230a of FIG. 2). In such an example, when an acknowledgment is received that one of the exchanges is open, all of the retry orders 412a-412f for that exchange are communicated to the exchange (e.g., at the maximum allowable rate), and those retry orders 412a-412f are cancelled or removed from the sequential list 700. In some examples, the remaining retry orders 412a-412f (e.g., the retry orders 412a-412f are associated with the other exchange that is not open), are moved up or rearranged in the sequential order 700 and continue to be communicated to the other exchange in the same manner. In some examples, the effective rate at which the remaining retry orders 412a-412f are to be communicated is recalculated after the first set or batch of retry orders 412a-412f were communicated to the first open exchange. In other examples, a separate sequential order may be generated for each of the different exchanges.

In some examples, only a subset of the retry orders 412a-412f is selected to be communicated to the exchange 406 in the sequential operation disclosed herein. For example, instead of arranging all of the retry orders 412a-412f in the sequential order 700 and communicating all of the retry orders 412a-412f one after another to the exchange 406, only the first, second and third retry orders 412a-c may be sequenced and communicated to the exchange 406. The effective rate or effective interval may be based on the retry intervals of the selected retry orders 412a-412c. Once an acknowledgment message is received from the exchange 406, the remaining ones of the retry orders 412a-412f, including the fourth, fifth and sixth retry orders 412d-412f that were not originally sequenced, are communicated to the exchange 406 (e.g., at the maximum allowable rate or exchange rate).

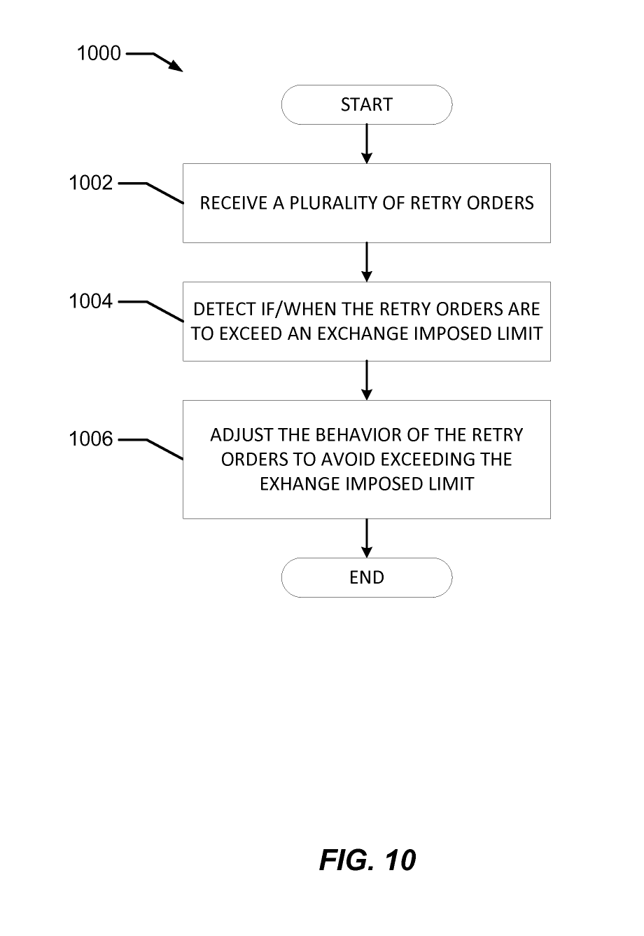

FIG. 10 illustrates a flow diagram of an example process or method 1000 to manage or control a plurality of retry orders to prevent the retry orders from exceeding bandwidth limitations (e.g., exchange link imposed limitations and/or system imposed limitations, overloading the system) and rendering the network inoperative (e.g., due to a system disconnect and/or system crash). The method 1000 may be implemented by, for example, the control module 600 of FIG. 6. The example method 1000 includes receiving a plurality of retry orders (block 1002). A retry order, as disclosed herein, a type of order for a tradeable object that includes one or more associated parameters that enable the retry order to be repeatedly communicated to an exchange to obtain a favorable position in the queue of the exchange once the exchange opens. The one or more associated parameters may include, for example, identification of a tradeable object, a price for the tradeable object, a quantity of the tradeable object, slop parameters, pay-up ticks, a start date and/or time, a number of retries, an interval between which the retry order is to be repeated and/or a rate at which the retry order is to be communicated.

The example method 1000 includes detecting if or when the retry orders are going to exceed an exchange imposed limit (e.g., bandwidth limit, capacity limit, etc.) (block 1004). As disclosed herein, in some examples the retry orders operate independently of each other, and each retry order is repeatedly communicated to the exchange over a common communication network or exchange link in accordance with its respective parameters. If the amount of messages or message orders sent over the exchange link exceed an exchange bandwidth limitation(s) (and/or system bandwidth limitation(s)), the communication network or exchange link may be terminated by the exchange and/or the system may stop functioning properly and become inoperative (e.g., due to a system crash). Therefore, the example method includes detecting if or when the retry orders are going to exceed the exchange imposed limit. In some examples, the detection occurs prior to communicating the retry orders. For example, prior to communicating the retry orders, the relative bandwidth may be calculated to detect if the resulting communications are going to exceed the exchange imposed limitations. In other examples, the system monitors for this situation while communicating the retry orders. Example systems and methods for detecting when a system is approaching an exchange limit are disclosed in U.S. application Ser. No. 13/718,949, as referenced above and incorporated herein by reference in their entireties.

The example method 1000 includes adjusting the behavior of the retry orders to avoid exceeding the exchange imposed limit (block 1006). In some examples, an effective rate is calculated or determined that defines the rate at which one or more of the retry orders is to be communicated to the exchange. For example, the effective rate may be based on an exchange rate (e.g., a maximum allowable rate) and/or on the fastest retry rate of the retry orders. In some examples, only one of the retry orders is to be communicated to the exchange while the remaining retry orders are withheld. In other examples, the retry orders are arranged or organized into a sequence in which the retry orders are to be communicated one at a time to the exchange. After an acknowledgment is received from the exchange, the remaining retry orders are communicated to the exchange because the exchange is open and accepting orders. In some examples, the remaining plurality of retry orders are sent simultaneously to the exchange. In other examples, the remaining plurality of retry orders are communicated to the exchange rate (e.g., the maximum allowable rate). By adjusting or altering the behavior of the retry orders, the retry orders are not all independently and simultaneously communicating with the exchange, which commonly leads to overloading of the communications network.

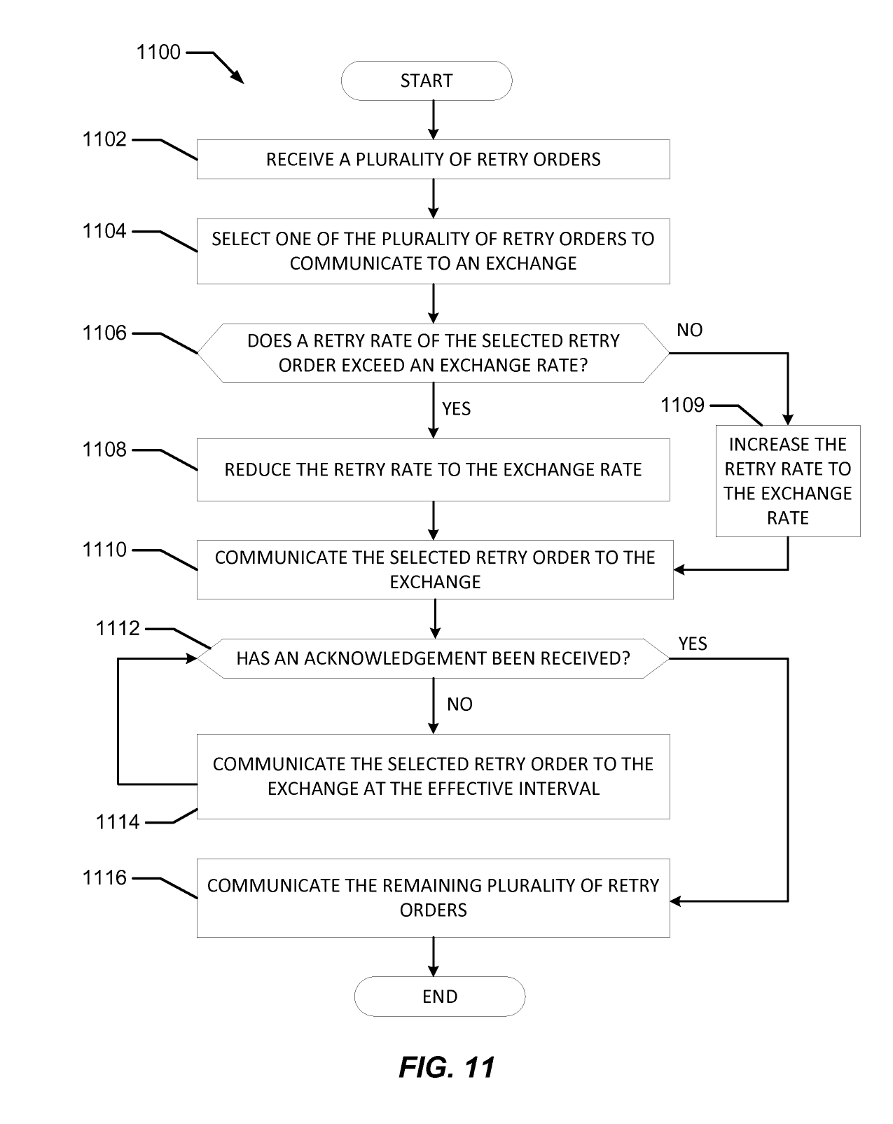

FIG. 11 illustrates a flow diagram of an example process or method 1100 to adjust the behavior of a plurality of retry orders and prevent the retry orders from exceeding bandwidth limitation(s) (e.g., exchange link imposed limitation(s) and/or system imposed limitation(s), etc.) designed to prevent overloading of the exchange and/or rendering the network inoperative (e.g., due to a system disconnect and/or system crash). The method 1100 may be implemented by, for example, the control module 600 of FIG. 6. The example method 1100 includes receiving a plurality of retry orders (block 1102). A retry order, as disclosed herein, is a type of order for a tradeable object that includes one or more associated parameters that enable the retry order to be repeatedly communicated to an exchange to obtain a favorable position in the queue of the exchange once the exchange opens. The one or more associated parameters may include, for example, identification of a tradeable object, a price for the tradeable object, a quantity of the tradeable object, slop parameters, pay-up ticks, a start date and/or time, a number of retries, an interval between which the retry order is to be repeated and/or a rate at which the retry order is to be communicated. For example, in the electronic trading system 600 of FIG. 6, the trading device 402 receives the retry orders 412a-412n.

The example method 1100 includes selecting one of the plurality of retry orders to communicate to the exchange (block 1104). In some examples, the selection is random. For example, in the electronic trading system 400 of FIG. 6, the control module 600 may select (e.g., randomly) the first retry order 412a to communicate to the exchange. In other examples, the selection is based on user input (e.g., an operator manually selects one of the retry orders 412a-412n for the control module 600 to communicate). In other examples, the selection may be based other factors such as, for example, when respective retry orders were placed (e.g., the first retry order placed is selected) and/or the retry rates of the respective retry orders (e.g., the retry order with the fastest retry rate is selected).

To determine an effective rate or rate at which the selected retry order is to be communicated to the exchange, the example method 1100 includes determining whether the selected one of the retry orders has a retry rate that exceeds an exchange rate (or a retry interval that is smaller than an exchange interval) (block 1106). As disclosed herein, a retry interval is an interval of time before a respective retry order is to be resent to the exchange, and a retry rate is the number of retries occurring in a period of time. If the retry rate is higher than the exchange rate (e.g., the maximum allowable rate), then the retry order would be communicated to the exchange at a rate that would exceed bandwidth limitations (i.e., the retry interval is smaller than the exchange interval). For example, in the electronic trading system 400 of FIG. 6, the control module 600 determines if a retry rate for one of the retry rates 412a-412n exceeds the exchange rate.

If the retry rate of the selected retry order exceeds the exchange rate, the example method 1100 includes reducing the retry rate to the exchange retry (or increasing the retry interval to the exchange interval) (block 1108). In this manner, the effective rate is set as the exchange rate (or the effective interval is set as the exchange interval). For example, in the electronic trading system 400 of FIG. 6, the control module 600 may set the effective rate at the exchange rate.

If the retry rate of the selected retry order does not exceed the exchange rate, then the effective rate may be set as the retry rate of the selected retry order. However, in some examples, even if the retry rate of the selected retry order does not exceed the exchange rate, the effective rate may still be increased to the exchange rate to allow the retry order to be communicated to the exchange as fast as possible. For example, the method 1100 includes increasing the retry rate to the exchange rate (e.g., the maximum allowable rate, the exchange limit) (block 1109). Therefore, the effective rate may be based on the exchange rate, the retry rate or another rate.

The example method 1100 of FIG. 11 includes communicating the retry order to the exchange (block 1110). For example, in the electronic trading system 400 of FIG. 6, the first retry order 412a may be communicated or sent to the exchange over the networks 408, 410. The example method 1100 includes determining (e.g., monitoring to determine) whether an acknowledgment indicating that the order has been received and accepted by the exchange (block 1112). If an acknowledgment has not been received, then the selected retry order is communicated again (e.g., repeated, resubmitted, reattempted) to the exchange at the effective interval (e.g., the exchange interval or the retry interval of the selected retry order) (block 1114). This process repeats until an acknowledgment is received. In other words, the selected retry order is repeatedly communicated to the exchange at the effective rate (e.g., the exchange rate or the retry rate of the selected retry order). While the selected retry order is repeatedly communicated to the exchange, the other remaining retry orders are not communicated the exchange. For example, in the electronic trading system 400 of FIG. 6, the first retry order 412a may be repeatedly communicated to the exchange 406 at an effective interval while the remaining plurality of retry orders 412b-412n are not communicated.

The example method 1100 includes communicating the remaining plurality of retry orders to the exchange (1116). After an acknowledgment is received from the exchange that one of the repeated attempts of the selected retry order is accepted at the exchange, the remaining plurality of retry orders are communicated to the exchange, which is open and accepting orders. In some examples, the remaining retry orders are sent simultaneously to the exchange. In other examples, the remaining retry orders are communicated to the exchange at the exchange rate. For example, in the electronic trading system 400 of FIG. 6, once an acknowledgement is received from the exchange 406 that the first retry order 412a has been accepted at the exchange 406, the control module 600 communicates the remaining plurality of retry orders 412b-412n to the exchange 406.

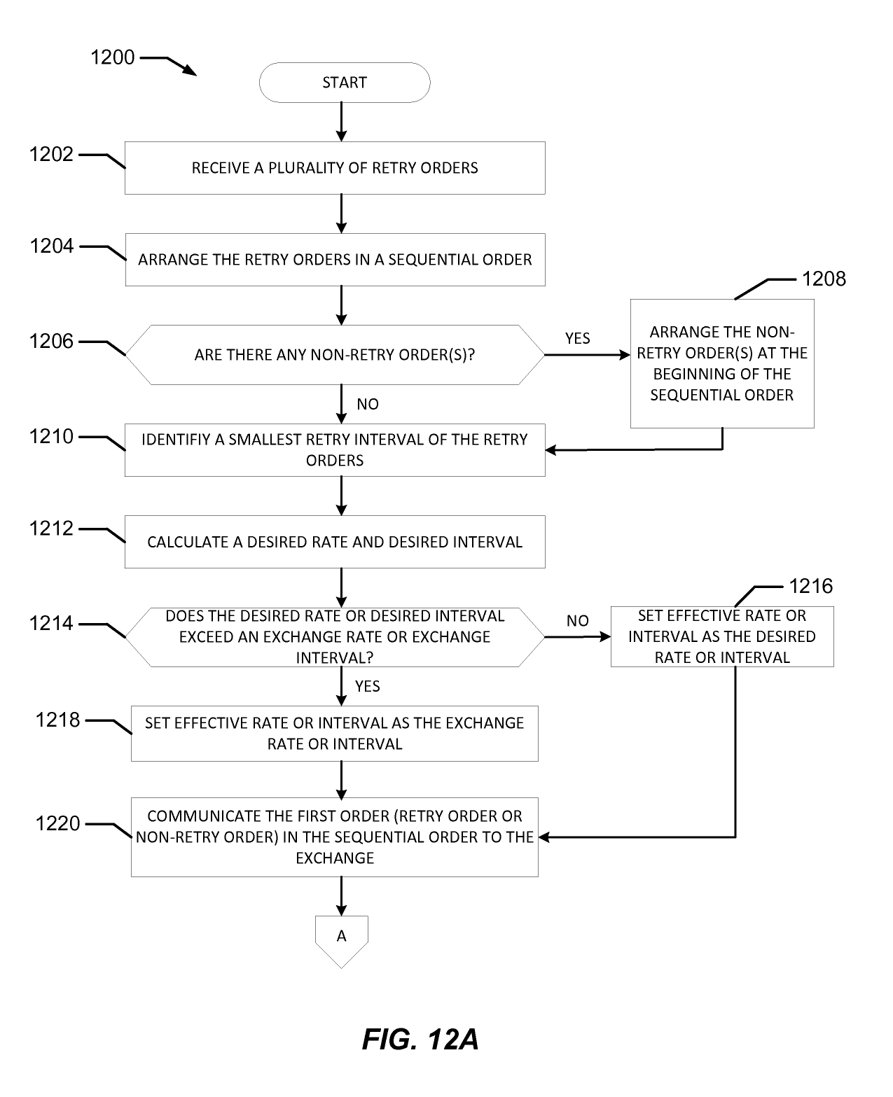

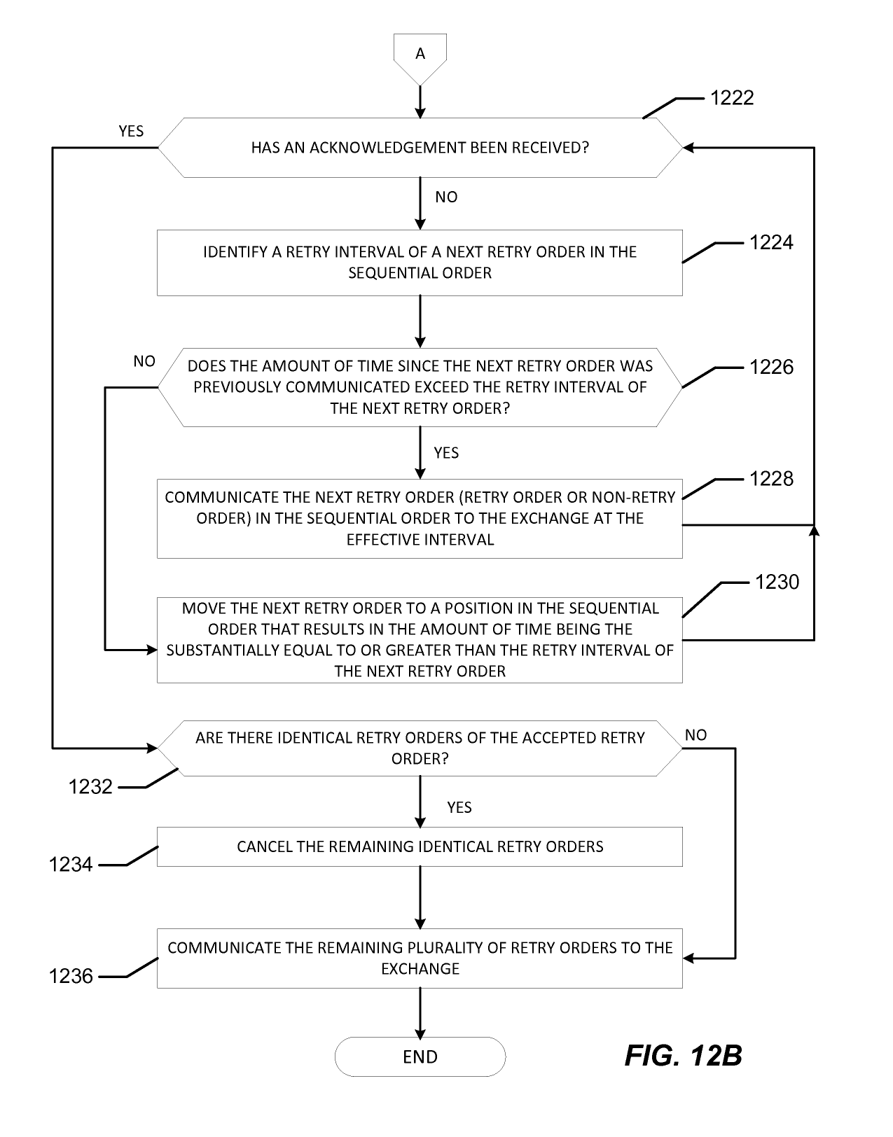

FIGS. 12A and 12B illustrates a flow diagram of another example process or method 1200 to adjust the behavior of a plurality of retry orders and prevent the retry orders from exceeding a bandwidth limitation(s) (e.g., an exchange imposed limitation and/or a system imposed limitation(s)) and rendering the network inoperative (e.g., due to a system disconnect and/or system crash). The method 1200 may be implemented by, for example, the control module 600 of FIG. 6. The example method 1200 includes receiving a plurality of retry orders (block 1202). A retry order, as disclosed herein, is a type of order for a tradeable object that includes one or more associated parameters that enable the retry order to be repeatedly communicated to an exchange to obtain a favorable position in the queue of the exchange once the exchange opens. The one or more associated parameters may include, for example, identification of a tradeable object, a price for the tradeable object, a quantity of the tradeable object, slop parameters, pay-up ticks, a start date and/or time, a number of retries, an interval between which the retry order is to be repeated and/or a rate at which the retry order is to be communicated. For example, in the electronic trading system 400 of FIG. 6, the trading device 402 receives the retry orders 412a-412n.

The example method 1200 includes arranging or organizing the retry orders into a sequential order or list (block 1204). The sequential order defines the order in which the retry orders are to be communicated, one at a time, to the exchange. The sequential order may repeat the succession of the retry orders over and over. In some examples, the retry orders are arranged in the sequential order based on the order in which they were placed or received (e.g., a serial communications order). Additionally or alternatively, the sequential order may be based on a per-operator basis and/or a per-firm basis. Examples of such a sequential order are disclosed in relation to FIGS. 6-9. For example, in the electronic trading system 400 of FIG. 6, the control module 600 may arrange the retry orders 412a-412f into the sequential order 700 of FIG. 7.

The example method 1200 includes determining whether there are any non-retry orders (e.g., hedge orders, children of synthetic stops, etc.) (block 1206). If there are any non-retry orders, the non-retry orders are arranged at the beginning of the sequential order (block 1208). For example, in the electronic trading system 400 of FIG. 6, the control module 600 may determine if there are any non-retry orders received at the trading device 402 and arrange the non-retry orders at the beginning of the sequential order 700.

To determine an effective rate or rate at which the retry orders are to be communicated to the exchange, the example method 1200 includes identifying the smallest retry interval of the plurality of retry orders (block 1210). Each of the retry orders may have a retry rate or retry interval associated with the respective retry order. As disclosed herein, a retry interval is an interval of time before a respective retry order is to be resent to the exchange, and a retry rate is the number of retries occurring in a period of time. A retry rate or retry interval may be set by a user. The retry order with the smallest retry interval also has the highest or fastest retry rate. For example, in the electronic trading system 400 of FIG. 6, the control module 600 may detect or identify the smallest retry interval of the retry orders 412a-412f.

The example method 1200 includes calculating a desired rate or desired interval (block 1212). In some examples, the desired rate is calculated by dividing the number of retry orders by the identified smallest interval. Thus, this desired rate is relatively higher than the identified higher retry rate (or lowest retry interval). With the desired rate, the desired interval can also be calculated. The desired rate or desired interval enables the retry order having the fastest retry rate or smallest retry interval to still be communicated according to its original retry rate or retry interval. For example, in the electronic trading system 400 of FIG. 6, the control module 600 may determine the desired rate by number of retry orders (e.g., six) by the lowest identifier interval (e.g., 100 ms). With the desired rate, the desired interval can also be calculated.

The example method 1200 includes determining whether the desired rate exceeds an exchange rate (or whether the desired interval is less than an exchange interval) (block 1214). The exchange rate defines the maximum allowable rate at which information (e.g., message or message orders) can be communicated without exceeding bandwidth limitations. If the desired rate is less than the exchange rate, then the effective rate is set at the desired rate (block 1216). If the desired rate exceeds the exchange rate, the effective rate is set as at the exchange rate (block 1218). Thus, the effective rate is set at either the exchange rate (e.g., the maximum allowable rate) or the desired rate (which accommodates the rate of the fastest retry rate). For example, in the electronic trading system 400 of FIG. 6, the control module 600 may determine if the desired rate exceeds the exchange rate, and the effective rate may be set as the lower of the desired rate or the exchange rate.

The example method 1200 includes communicating a first order (e.g., either a retry order or a non-retry order) to the exchange (block 1220). For example, in the electronic trading system 400 of FIG. 6, the first retry order 412a may be communicated or sent to the exchange over the networks 408, 410. The method 1200 includes determining (e.g., monitoring or determine) whether an acknowledgement has been received from the exchange (block 1222). If an acknowledgment has not been received, then the next retry order in the sequential order can be communicated to the exchange at the effective interval. For example, in the example timing diagram 800 of FIG. 8, the first retry order 412a is sent at t₀. If the effective interval has passed as an acknowledgment is not yet received, then the second retry order 412b is to be set at t_{i.}

In some examples, the retry rates or retry intervals of the respective retry orders should not be violated. In order to preserve the retry rates or retry intervals (e.g., as set or defined by a user), the example method 1200 includes identifying the retry interval of the next retry order in the sequential list (block 1224). The example method includes determining whether the time since the next retry order has been last communicated to the exchange exceeds the retry interval of the next retry order (block 1226). During the first part of the sequential order, none of the orders have been communicated yet, so each of the retry orders may all be communicated according to the effective interval. When the succession of the retry orders is repeated, however, the time since the next retry order has been last communicated to the exchange is compared to the retry interval of the next retry order. For example, in the electronic trading system 400 of FIG. 6, the control module 600 may be compare the time since the last next retry order 412a-412f in the sequential order 700 was last communicated to the retry interval of the respective retry order 412a-412f.

If the amount the amount of time since the next retry order has been communicated to the exchange is equal to or exceeds the retry interval for the next retry order, the method 1200 includes communicating the next retry order to the exchange at the effective interval (1228). Using the effective interval, the retry rate or retry interval for the specific retry order is not violated by being communicated relatively quicker or faster than the retry rate or retry interval of the respective retry order. Additionally, in some examples, the next retry order is sent only if an acknowledgment has not yet been received. For example, in the example timing diagram 900 of FIG. 9, the first retry order 412a is resent at t₆, because the time since the first retry order 412a was previously sent at t_{o is} 100 ms, which is equal to the retry interval of the first retry order 412a.

If the time since the next retry order was previously communicated does not exceed the retry interval of the next retry order, the example method 1200 includes moving (e.g., rearranging, reorganizing, repositioning, etc.) the next retry order to a position in the sequential order that results in the amount of time being equal to or greater than the retry interval of the next order (block 1230). By moving the next retry order, the user-set retry rate or interval is not violated. Additionally, because the next retry order is repositioned into a position that results in an amount of time substantially matching the retry interval of the next retry order, instead of being skipped or moved to the end of the sequential order, the next retry order is still communicated relatively closely to the retry rate or retry interval (e.g., the user-defined retry rate or retry interval as originally intended). Further, this reposition prevents against undesired punishment of those retry orders with relatively slower retry rates. For example, in the example timing diagram 900 of FIG. 9, the second retry order 412b is to be resent at t₇, which results in an amount of time (e.g., 100 ms) since the second retry order 412b was previously (e.g., at t₁) that is less than retry interval (e.g., 120 ms). In such an example, the control module 600 moves the second retry order 412b to a position (e.g., at t₉) in the sequential order 700 that results in the amount of time being equal to or great than (e.g., as close to as possible but greater than) the retry interval (e.g., 120 ms) of the second retry order 412b.

During this time, the example method includes determining whether an acknowledgment has been received (block 1222). This process repeats itself over and over. In other words, if the retry interval of next retry order is not violated (and an acknowledgment has not yet been received), the next retry order is communicated at the effective interval, and so forth.

After an acknowledgment is received, the method 1200 includes determining whether there are existing retry orders in the sequential order that are identical as the retry order that was accepted at the exchange (block 1232). As disclosed herein, there may be a situation where a retry order is entered multiple times for the same exact tradeable object to increase the amount of times the retry order is communicated in the sequential order. If there are multiple identical retry orders, then the repeated orders are cancelled (block 1234), so that the same order is not repeatedly sent to the exchange.

The example method includes communicating the remaining plurality of retry orders to the exchange (block 1236). In some examples, the remaining plurality of retry orders are sent simultaneously to the exchange. In other examples, the remaining plurality of retry orders are communicated to the exchange at the exchange rate (e.g., the maximum allowable rate). For example, if the effective rate is less than the exchange rate, then the retry orders are being sent to the exchange at a rate that is slower than the allowable rate. Therefore, once the exchange is open, the remaining retry orders may be communicated at the exchange rate, which is relatively faster, so that the retry orders may be placed in the queue in the most favorable position. In some examples, the plurality of orders are communicated in the sequential order. Thus, when the identical retry orders are cancelled, the rest of the retry orders in the sequential order are moved up one position, thereby enabling the retry orders to be sent faster. For example, in the electronic trading system 400 of FIG. 6, once the trading device 402 receives an acknowledgment that one of the retry orders 412a-412n have been received at the exchange 406, the remaining retry orders 412a-412n are communicated to the exchange

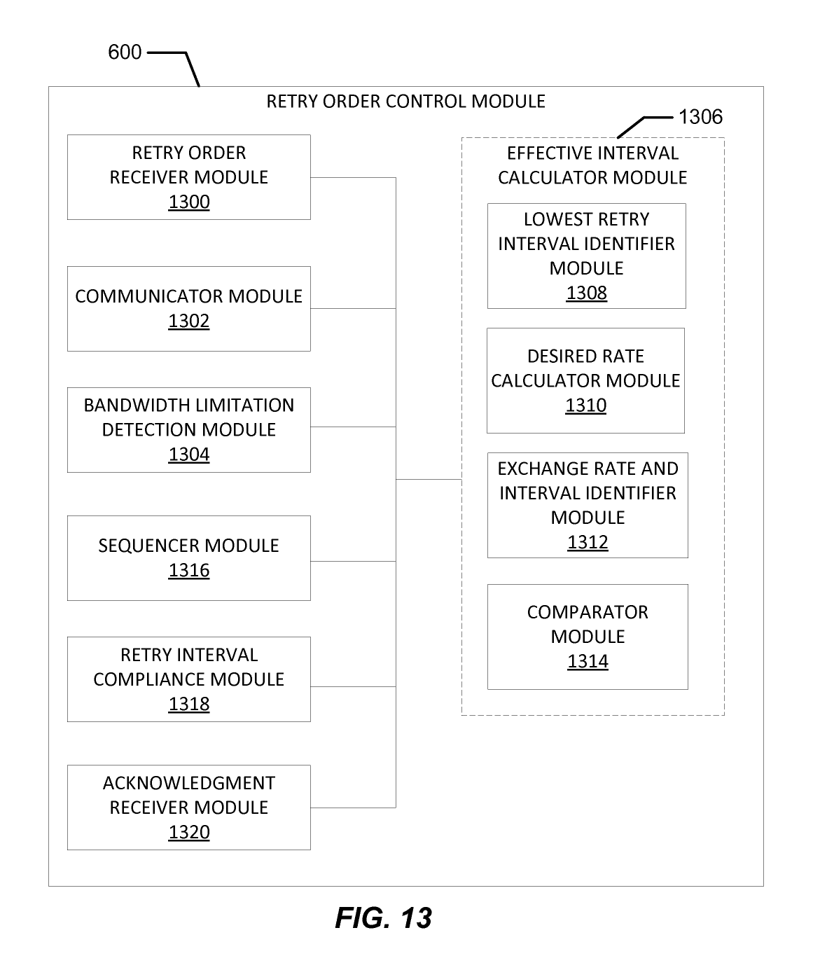

FIG. 13 is a block diagram of the example retry order control module 600 that may implement and/or execute the example operations of FIGS. 10-12. In some examples, the module 600 may be implemented as part of software (or an application) associated with the trading device 402 and/or the gateway 404 of FIG. 6. In some examples, the control module 600 may be implemented as computer implemented code or instructions operable independent of software associated with the trading device 402 and/or the gateway 404. In some examples, the features and functionality of the control module 600 may be implemented in hardware operable in connection with the trading device 402 and/or the gateway 404 of FIG. 6.

The example module 600 of FIG. 13 includes a retry order receiver module 1300 to receive one or more retry orders at, for example, the trading device 402 and/or the gateway 404. For example, one or more retry orders may be entered or placed by one operator on the trading device 402 or by multiple operators (e.g., multiple brokers are a brokerage firm) sharing the same communication link (e.g., the networks 408, 410) to an exchange. The example module 600 of FIG. 13 includes a communicator module 1302 to communicate the retry order(s) (received at the retry order receiver module 1300) to an exchange such as, for example, the exchange 406 of FIG. 4.

To detect if the retry orders are going to exceed bandwidth limitation(s) (e.g., exchange imposed limitation(s) and/or system imposed limitation(s)), the control module 600 includes a bandwidth limitation detection module 1304. The bandwidth limitation detection module 1304 may be preprogrammed with an upper threshold or limitation that is implemented by the exchange and/or the system. In other examples, the bandwidth limitation detection module 1304 to detects when the limitations are being approached. Example systems and methods for detecting when a system is approaching an exchange limit are disclosed in U.S. application Ser. Nos. 13/718,949, as referenced above and incorporated herein by reference in their entireties.

To manage the speed at which the retry order(s) are communicated to the exchange, the retry order control module 600 includes an effective interval calculator module 1306. The effective interval calculator module 1306 calculates an effective interval at which one or more of the retry(s) are communicated to the exchange. The effective interval calculator module includes a lowest retry interval identifier module 1308 to identify the lowest retry interval of the retry order(s). As disclosed herein, a retry order includes a plurality of parameters including a retry interval that defines the amount of time between repeated orders for the respective retry order. The retry intervals may be set by a user. The effective interval calculator module 1306 includes a desired rate calculator module 1310 to calculate a desired rate at which the retry order(s) are to be communicated to the exchange. In some examples, the desired rate is calculated by dividing the total number of retry order(s) by the lowest retry interval identified by the lowest retry interval identifier module 1308. For example, if the lowest retry interval of the retry order(s) is 100 ms, and there are a total of 1000 retry order(s), then the desired rate is 10,000 orders/second, which results in a desired interval of 0.1 ms.

The example effective interval calculator module 1306 of FIG. 13 includes an exchange rate and interval identifier module 1312 to identify the maximum allowable rate of the exchange (or the lowest allowable interval of the exchange). To determine an effective interval for communicating the retry order(s), the effective interval calculator module 1306 includes a comparator module 1314 that compares the desired interval (calculated by the desired rate calculator module 1310) to exchange interval (identified by the exchange rate and interval identifier module 1312). The higher of the desired interval or the exchange interval is set as the effective interval. In other words, if the desired interval is higher than the exchange interval, the retry order(s) will be communicated at a rate that does not exceed the exchange rate and, thus, there will not result in overloading of the communication link. However, if the desired interval is less than the exchange interval, the exchange interval is set as the effective interval, which is the maximum allowable interval or rate and, thus, prevents the retry order(s) from being communicated faster than the exchange interval and overloading the communication link.

The example retry order control module 600 includes a sequencer module 1316 to arrange or organize the retry order(s) into a sequential order or list. The sequential order may be based on, for example, when the retry order(s) were placed, on a per-operator basis, and/or on a per-firm basis. In other examples, the sequential order may be based on other factors. The communicator module 1302 communicates the retry order(s) one at a time in accordance with the sequential order set by the sequencer module 1316. The retry order(s) are communicated to the exchange at the effective interval calculated by the effective interval calculator module 1306.

The example retry order control module 600 includes a retry interval compliance module 1318 to determine if a retry order is to be communicated in an amount of time that is less that its associated retry interval. The retry order(s) may include metadata that indicates the last time (e.g., via a time stamp) the respective retry order was communicated to the exchange. Because the effective interval may be relatively smaller than the respective retry interval, the retry order may be arranged to be communicated to the exchange at an interval that is less than its associated retry interval. If this occurs, the sequencer module 1316 may rearrange or reposition the retry order into another position in the sequential list. For example, the sequencer module 1316 may move the retry order into a position in the sequential order that results in a time lapse that is substantially equal to or greater than the retry interval such that the retry interval of the retry order is not violated.

In the illustrated example, the retry order control module 600 includes an acknowledgment receiver module 1320 that is to receive an acknowledgment from the exchange in response to one of the retry order(s) being accepted or confirmed at the exchange. Once an acknowledgment has been received, the market is open and the communicator module 1302 communicates the remaining plurality of retry order(s) to the exchange. In some examples, the remaining retry order(s) are communicated at the exchange rate or exchange interval (e.g., identified by the exchange rate and interval identifier module 1312). In some examples, the remaining retry order(s) can be communicated in the same sequential order established by the sequencer module 1316. In other examples, the remaining retry order(s) may be communicated substantially simultaneously if doing so does not exceed the exchange rate or interval.

Although the example systems and methods disclosed herein are described in relation to trading systems and retry orders, it is to be understood the example systems and methods may be implemented in other fields or industries to prevent overloading of a system and exceeding capacity limitations of a network.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, by a computing device, a plurality of retry orders, wherein each of the plurality of retry orders is defined by a first parameter that represents a retry interval;
organizing, by the computing device, the received plurality of retry orders for communication to an exchange, wherein the organized plurality of retry orders are arranged in a sequential order based on the retry intervals of the plurality of retry orders;
communicating, by the computing device, each of the plurality of retry orders to the exchange according to the sequential order;
receiving, by the computing device, an acknowledgement from the exchange in response to one of the plurality of retry orders sequentially communicated to the exchange; and
communicating, by the computing device, the remaining plurality of retry orders to the exchange in response to the received first acknowledgement.

2. The method of claim 1, wherein the remaining plurality of orders are communicated at a maximum exchange rate.

3. The method of claim 1, wherein each of the plurality of retry orders is defined by a second parameter that represents a retry number.

4. The method of claim 1, wherein the sequential order is a serial communications order.

5. The method of claim 1, wherein the plurality of retry orders are arranged in the sequential order based on an exchange interval.

6. The method of claim 1 further comprising identifying, at the computing device, a smallest retry interval of the plurality of retry orders.

7. The method of claim 6, wherein the plurality of retry orders are arranged in the sequential order based on the smallest identified retry interval.

8. The method of claim 1, wherein the plurality of retry orders are arranged in the sequential order based on an order of receipt.

9. A method comprising:
receiving, by a computing device, a plurality of retry orders, each of the retry orders comprising a retry interval defining an amount of time that is to occur between repeated orders of the respective retry order;
arranging, by the computing device, the plurality of retry orders into a sequential order in which the plurality of retry orders are to be sent to an exchange;
determining, by the computing device, an effective interval, the effective interval defining an amount of time that is to occur between communicating each of the plurality of retry orders in the sequential order to the exchange;
communicating, by the computing device, the plurality of retry orders to the exchange according to sequential order at the effective interval;
determining, by the computing device, if a first retry order of the plurality of retry orders is to be communicated to the exchange in an amount of time that is less than the respective retry interval of the first retry order; and
rearranging, by the computing device, the first retry order in the sequential order when the determined amount of time is less than the respective retry interval by moving the first retry order to a later position in the sequential order where an amount of time to occur before the first retry order is to be communicated to the exchange is substantially the same or greater than the respective retry interval of the first retry order.

10. The method of claim 9, wherein the sequential order is based on when the respective retry orders are received by the computing device.

11. The method of claim 9 further comprising:
identifying, by the computing device, a smallest retry interval of the plurality of retry intervals;
calculating, by the computing device, a desired rate based on the smallest retry interval and an amount of retry orders; and
calculating, by the computing device, a desired interval based on the desired rate, wherein the effective interval is the larger of (1) the desired interval or (2) an exchange interval.

12. The method of claim 9 further comprising receiving, by the computing device, an acknowledgement from the exchange in response to one of the plurality of retry orders.

13. The method of claim 12 further comprising communicating, by the computing device, the remaining plurality of retry orders to the exchange in response to the received acknowledgment.

14. The method of claim 13, wherein the remaining plurality of retry orders are to be communicated at an exchange rate.

15. The method of claim 12, wherein a set of the plurality of retry orders is the same as the retry order that received the acknowledgment.

16. The method of claim 15 further comprising:
cancelling, by the computing device, the set of retry orders after the acknowledgement is received; and
communicating, by the computing device, the remaining plurality of retry orders to the exchange.

17. The method of claim 9, wherein the sequential order comprises a repeating succession of the plurality of retry orders.

18. The method of claim 9, wherein the plurality of retry orders are to be arranged in the sequential order based on an operator that placed the respective retry order.

19. The method of claim 9, wherein the plurality of retry orders are to be arranged in the sequential order based on a firm of operators that placed the respective retry order.

20. The method of claim 9, wherein the effective interval is less than an amount of time that is to occur before receiving a rejection or the acknowledgment from the exchange.

21. The method of claim 9 further comprising:
receiving, by the computing device, a non-retry order; and
arranging, by the computing device, the non-retry order at the beginning of the sequential order.

22. A method comprising:
receiving, by a computing device, a first retry order and a second retry order;
selecting, by the computing device, one of the first retry order or the second retry order to communicate to an exchange;
communicating, by the computing device, the selected one of the first retry order or the second retry order to the exchange;
receiving, by the computing device, an acknowledgment from the exchange in response to the selected one of the first retry order or the second retry order communicated to the exchange; and
communicating, by the computing device, the other of the selected one of the first retry order or the second retry order to the exchange after receiving the acknowledgment.

23. The method of claim 22, wherein the selected one of the first retry order or the second retry order is to be communicated to the exchange at an exchange rate.

24. The method of claim 22, wherein the other of the selected one of the first retry order or the second retry order is not to be communicated to the exchange until the acknowledgment is received from the exchange.

25. The method of claim 22, wherein the selected one of the first retry order or the second retry order is selected at random.

26. The method of claim 22, wherein the selected one of the first retry order or the second retry order is selected based on user input.

27. The method of claim 22, wherein the first retry order has a first retry interval and the second retry order has a second retry interval different than the first retry interval.

28. The method of claim 27, wherein the selected one of the first retry order or the second retry order is selected based on the first retry interval and the second retry interval.

29. The method of claim 27, wherein the selected one of the first retry order or the second retry order is to be communicated to the exchange at the respective first interval or second interval.

30.-87. (canceled)
